(19) United States
(12) Patent Application Publication
(10) Pub. No.: US 2018/0077438 A1
(43) Pub. Date: Mar. 15, 2018

(54) STREAMING AUDIO AND VIDEO FOR SPORTING VENUES

(71) Applicant: Maxx Sports Technologies Ltd, The Woodlands, TX (US)

(72) Inventors: Barrie Hansen, The Woodlands, TX (US); Michael Malambri, The Woodlands, TX (US)

(21) Appl. No.: 15/701,308

(22) Filed: Sep. 11, 2017

Related U.S. Application Data
(60) Provisional application No. 62/385,605, filed on Sep. 9, 2016.

(51) Int. Cl. H04N 21/25; H04N 21/458

(52) U.S. Cl. CPC H04N 21/25; H04N 21/458

(57) ABSTRACT

A system and method for generating user customized video streams includes a video server configured to store video streams captured during a sporting event, a user interface for receiving user input, and a processor that dynamically determines which video streams to select, in accordance with the user input, during the sporting event for generating a user customized video stream. The user can select video streams presented on the user interface, or the processor can automatically select a video streams based on a user selected feature, such as a particular player. The processor can perform image analysis of video streams to determine which of the video streams visually presents the player, and can automatically select the appropriate video stream for the user customized video stream.

### CROSS-REFERENCE TO RELATED APPLICATIONS

This application claims the benefit of U.S. provisional patent application Ser. No. 62/385,605, filed Sep. 9, 2016 and is incorporated herein by reference in its entirety.

### TECHNICAL FIELD

The subject application teaches embodiments that relate generally to streaming audio and video for sports venues, and specifically to video and audio capture, processing, and streaming of sporting events and practices.

### BACKGROUND

Professional broadcasters capture live action events at sporting venues and broadcast live or recorded video to subscribers and television viewing audience. When sporting events are broadcast, viewers generally are limited to viewing an event through the viewpoint of a single camera selected by producers from one or more cameras that capture the sporting event. Most practices and some pre-season games are not broadcast, and minor league games, club level events, and high school sporting events are rarely broadcast or recorded at all. Cameras used by broadcasters are typically large complicated devices designed for professional camera personnel and include high resolution image capturing elements and expensive lenses with variable zoom. Cameras are typically mounted on tripods, slung from wires above sporting events, or attached to weight-bearing harnesses strapped to camera personnel who position themselves nearby to the action taking place on the field. Cameras and expertise for operating the cameras creates a barrier for new entrants to the market, local small-market producers, schools, and individuals wanting to create audio and video of sporting events, either for their own use or for monetizing their work through third party subscription. Broadcasters can offset the costs of obtaining, maintaining, and operating cameras, editing systems, and other broadcasting expenses through marketing and/or subscription revenues from their larger base of advertisers and/or consumers. The present disclosure presents new modalities for streaming audio and video from sporting venues to viewers.

### SUMMARY

In a first example embodiment, a method of generating a user customized video stream includes a plurality of captured video streams of an event where each video stream is captured video from one of a plurality of image capturing devices, such as a video camera disposed in a public venue or a wireless video camera disposed on a person associated with the event. The method includes receiving a user selection and determining a focus video stream based at least in part on the user selection. The method further changing the focus video stream from a first video stream to a second video stream, and generating a user customized video stream from the focus video stream. The method can include changing the focus video stream based on a user selection of one of the plurality of video streams or based on a user selected feature such as a player at a sporting event. The method can include analyzing some or all of the plurality of video streams to determine if a selected player is visually present, for example by using image processing to identify a player's number on their jersey, and selecting one of the video streams where the player is visually present as the focus video stream. The image processing can include machine learning and computer vision, as well as other artificial intelligence algorithms to determine the player's number. The method can include receiving user created content that is merged with the focus video stream to generate a user customized video stream. The method can include storing the user customized video stream on a video server and associating the user customized video stream with a user created channel. The method can include inviting other user to stream a user customized video stream from the user created channel.

In a second example embodiment, a system for generating user customized video streams includes a video server that is configured to store a plurality of video streams captured at an event such as a sporting event at a public venue. The system includes an input, for example a user interface, that is configured to receive a user selection, and a processor. The processor is configured to determine a focus video stream based at least in part on the user selection, change the focus video from a first video stream to a second video stream, and generate a user customized video stream from the focus video stream. The system can include image capturing devices such as video cameras positioned at different vantage points at the venue or wireless video cameras placed on persons associated with the event, for example video cameras integrated into helmets worn by players at a sporting event. The input can be further configured to receive user created content and the processor can be configured to combine the user created content with the focus video stream to generate the user customized video stream.

In a third example embodiment, a system for generating a user created video stream includes an audio/video server, and a processor. The audio/video server is configured to store audio/video streams captured during a sporting event at the sporting venue, where each audio/video stream is associated with an audio/video capturing device such as a wireless helmet camera associated with a player, a microphone positioned to detect sound from players during play, and video cameras positioned at unique vantage points in the sporting venue. The processor is configured to dynamically determine which audio/video stream to select as the user customized video stream during playback of the sporting event. The processor can select an audio/video stream in accordance with a user input received from an associated user interface that displays the audio/video streams to the user, or the processor can perform image processing of the audio/video streams to determine and select an audio/video stream in which a user selected player is visually present.

### BRIEF DESCRIPTION OF THE DRAWINGS

FIG. 1 is a diagram of an audio/video system for sporting venues according to an embodiment of the disclosure

FIG. 2 is a diagram of an impact-resistant camera housing according to an embodiment of the disclosure.

FIG. 3 is a diagram of a sports helmet with integrated audio/video system according to an embodiment of the disclosure.

FIG. 4 is a diagram of example audio/video and network components according to an embodiment of the disclosure.

FIG. 5 is a flowchart of example operations for networking audio/video components according to an embodiment of the disclosure.

FIG. 6 is a flow diagram of example data connections according to an embodiment of the disclosure.

FIG. 7 is a diagram of an example screen for selecting from multiple audio and video feeds according to an embodiment of the disclosure.

FIG. 8 is a flowchart of example operations for custom content creation according to an embodiment of the disclosure.

FIG. 9 is a diagram of components of an example computing device configured for audio/video operations according to an embodiment of the disclosure.

FIG. 10 is a functional block diagram of example modules of a custom content creation system.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

The systems and methods disclosed herein describe various aspects of real-time video for sporting venues. Although the disclosed system and method are described below with regard to one or more computing devices and in particular mobile computing devices, the system and method can be used with any suitable computing device including but not limited to mobile phones, smart phones, pad computing devices, laptops, personal computers, desktops, servers, embedded controllers, and so forth. Among other various possibilities

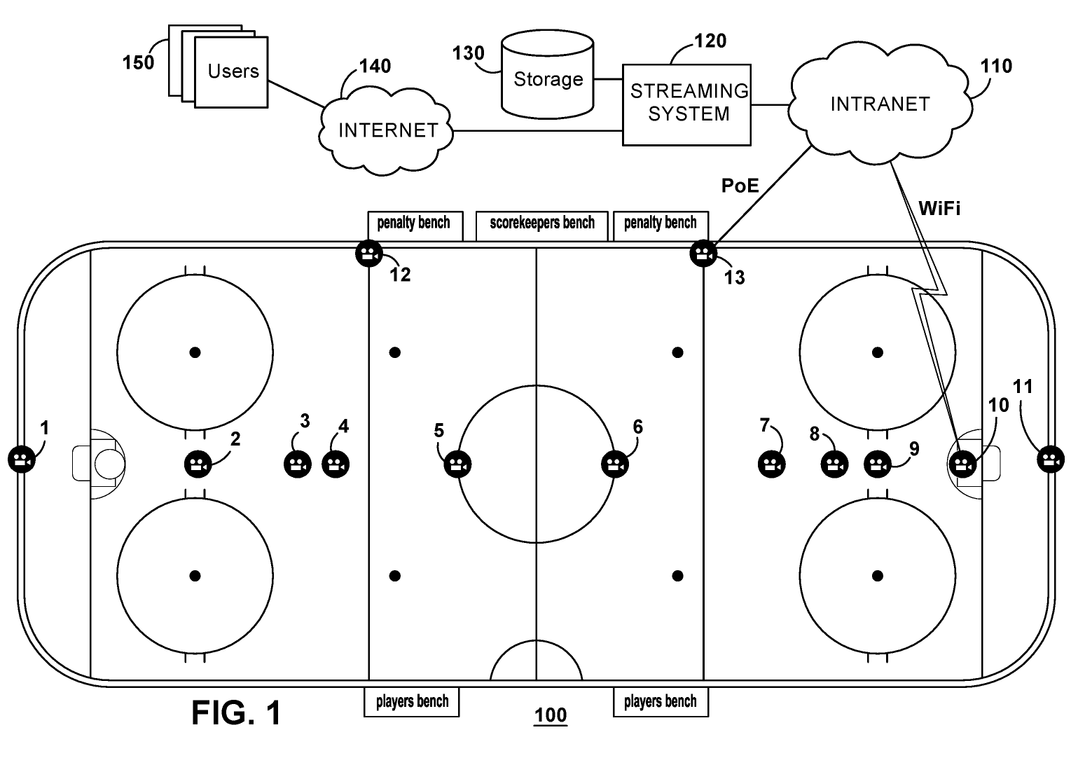

Turning to FIG. 1, an audio/video system 100 for sporting venues is presented. The system 100 includes one or more audio/video streaming devices illustrated as cameras 1, 2, 3, 4, 5, 6, 7, 8, 9, 10, 11, 12, and 13. For example, cameras 1, 11, 12, and 13 can be fixed cameras in an arena, cameras 2, 5, 6, and 9 can be movable cameras that follow players or the action in the arena, camera 4 can be a camera positioned ideally to point at a scoreboard, cameras 3, 7, and 8 can be helmet cameras mounted to the helmets of certain players, and camera 10 can be a pair of helmet cameras configured to provide a view with a 3D virtual reality view from a player's perspective, such as a goalie's view.

The devices can be cameras, microphones, wireless cameras, wireless microphones, helmet cams, and so forth. Wired communications can be provided over Ethernet, for example using UDP or TCP protocols as would be understood in the art. In a configuration, a wired microphone can include an analog transducer that is coupled to a digitizer; the digitizer converts the analog signal into a suitable digital format such as MP3. Typically, wired microphones are analog devices that are connected via cables to a head end unit; long cables require sufficient electrical insulation to avoid interference and substantial gauge wire that makes them expensive and heavy. Even with quality electrical insulation and properly gauged wire, purely analog solutions are subject to attenuation losses and noise, affecting the signal-to-noise ratio of the signal received at the head end unit. By immediately converting the signal from the analog transducer into a digital signal, the digital signal can be carried on less expensive, longer cables without the subject attenuation losses and lower signal-to-noise ratio of a purely analog system. Power over Ethernet (PoE) advantageously can be used to both provide power to devices and to provide a wired communications medium for the devices. Wireless communications can be effected using Wi-Fi or other wireless protocols, including but not limited to Bluetooth.

The system 100 can include a private network, shown as intranet 110, configured for data communications between the devices and a streaming system 120. The streaming system 120 is configured to support audio and video streams from the devices, and convert them as required, as described below in greater detail. The streaming system 120 can include storage 130 for storing the audio and video streams. The streaming system 120 can allow users 150 to stream audio and video from the devices or from storage 130.

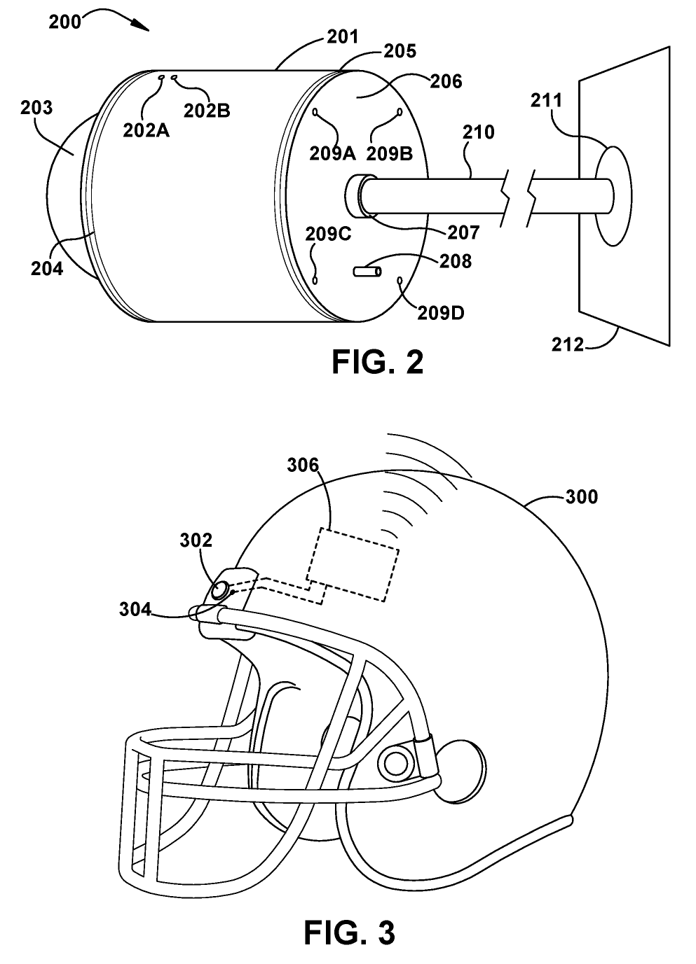

Turning now to FIG. 2, an example impact resistant camera housing 200 is presented. The camera housing 200 is configured to withstand vibrations, shocks, and impact to a camera mounted within the camera housing 200. For example, in a hockey arena it is possible for cameras to come into contact with a flying hockey puck, or be impacted by a hockey stick or a player. The camera housing 200 can protect the camera from the impact, and also ensure that parts from a damaged camera, such as glass or electronics, do not end up on spectators or players or on the ice where sharp or heavy pieces might cause injury.

The camera housing 200 is structurally configured to protect the camera while allowing connection to electrical components such as cables or wires for power and data communications. The camera housing 200 can also be configured to provide clean air for the camera, and remove heat dissipated by the camera.

The camera housing 200 comprises a dome assembly that attaches at one end of a drum 201. The dome assembly comprises a transparent dome cover 203 and a retainer ring 204. The dome assembly can be coupled to the drum 201 using complementary threading, screws, nuts, bolts, washers, (not shown) and the like as would be understood in the art.

A camera can be mounted inside the camera housing 200, for example on a support structure having support members (not shown) that contact the interior wall of the drum 201. The support members can be configured to dampen vibrations as would be understood in the art. An example support structure can be a disk that rests against pliable dampeners that act as support members and that seat the disk along a cross section of the drum 201. A camera can be mounted to the disk, for example using screws or other suitable fasteners.

The drum 201 can include threaded holes 202A, 202B to attach camera angle travel limiters inside the drum 201 thereby limiting the camera rotation to a predetermined angle. Camera angle travel limiters work by limiting camera rotation angle to prevent the camera from becoming damaged during rotation, or to ensure that the camera is always pointed at a certain area of the arena. For example, it may be desirable to use angle travel limiters to ensure that a camera cannot be pointed at spectators accidentally. In a configuration, the threaded holes 202A, 202B do not penetrate the drum 201 and are accessible only from the inside of the drum 201.

A mounting cover comprises retainer ring 205 and cover plate 206. Cover plate 206 can include collar 207 configured to accept a support rod 210 that connects to a support structure 211 and mounting plate 212. The mounting plate 212 can be attached to a structure in the arena such as a wall, ceiling, support beam, and so forth. A quick link 208 can be used as a backup failsafe to further anchor the camera housing 200 to a wall or support structure, for example using metal strings, or rope. This can be used to ensure that the camera housing 200 does not fall onto spectators, players, or the arena if the mounting plate 212 were become detached for any reason. The support rod 210 can be hollow, providing for passage for electrical components such as wires, cables, and so forth. The cover plate 206 can include threaded screw holes 209A, 209B, 209C, 209D for connecting the cover plate 206 and ring 205 to the drum 201. In a configuration, long screws can be used that pass through the drum 201 and also connect the dome assembly to the drum 201.

Referring now to FIG. 3, a helmet 300 that includes a helmet cam is presented. The helmet 300 can include one or more cameras 302 and/or microphones 304. The camera 302 can use a standard definition or high definition frame size and frame rate such as a 720p, 1080i, 1080p, or 2k at 30 frames per second (fps), 60 fps, or 120 fps, or lower frame rates. A helmet cam for providing a 3D virtual reality video feed can include two spatially separated cameras 302 as would be understood in the art. In a configuration, the microphone 304 can include an analog transducer that is coupled to a digitizer; the digitizer converts the analog signal into a suitable digital format such as MP3. In a configuration the camera 302 and microphone 304 can be a single unit. The camera 302 and microphone 304 are in communication with an embedded controller 306. The embedded controller 306 can include custom designed electronics, for example a chip or microcontroller with a Wi-Fi or other antenna. In a configuration, the embedded controller 306 can include a modified smartphone. In one such configuration, the camera element and microphone element from a smartphone can be displaced from the modified smartphone and used as camera 302 and microphone 304. The embedded controller 306 can stream one or more video or audio streams from the camera 302 and/or microphone 304. Data communications from the embedded controller 306 can include Wi-Fi.

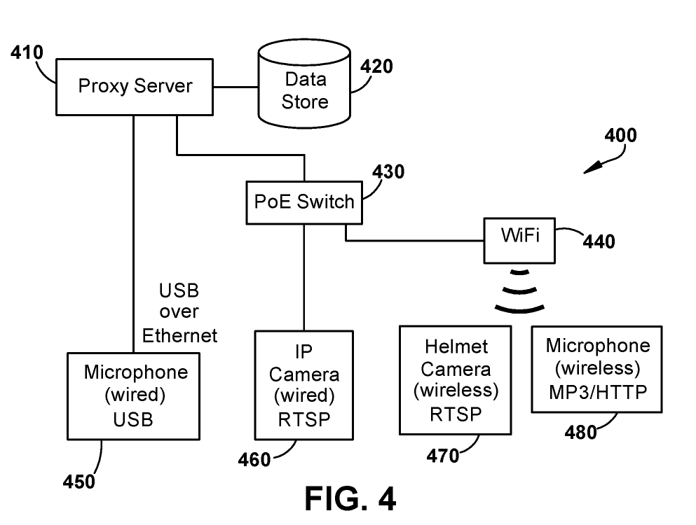

Referring now to FIG. 4, example audio/video and network components 400 are presented. A microphone 450, for example a wired microphone configured to be placed near the glass surrounding a hockey rink, can be connected to a proxy server 410 via an Ethernet cable such as a CAT 6 cable. The communications protocol between the proxy server 410 and microphone 450 can be USB over Ethernet, among other possible protocols as would be understood in the art. The Ethernet cable can provide power to the microphone 450.

An IP camera 460, for example an IP camera configured to be placed inside of the impact resistant camera housing 200 of FIG. 2, can be connected to a PoE switch 430 using a CAT 6 cable. The PoE switch 430 can provide power to the IP camera 460. The communications protocol between the proxy server 410 and IP camera 460 can be RTSP or real-time streaming protocol, among other possible protocols as would be understood in the art.

A wireless helmet camera 470, for example as described in helmet 300 of FIG. 3, can be configured for wireless data communications with the proxy server 410 via Wi-Fi router 440. Wi-Fi router 440 can be connected to the proxy server 410 via PoE switch 430 or by a direct connection to the proxy server 410. The communications protocol between the proxy server 410 and wireless helmet camera 470 can be RTSP or real-time streaming protocol, among other possible protocols as would be understood in the art.

Similarly, a wireless microphone 480 can be configured for wireless data communications with the proxy server 410 via Wi-Fi router 440. The proxy server 410 can receive digitized audio, for example an MP3 stream, by establishing a connection with the wireless microphone, for example using hypertext transfer protocol, or HTTP. Other communication protocols could also be used as would be understood in the art.

The proxy server 410 receives audio and video streams from microphones 450, 480 and cameras 460, 470. The proxy server 410 can store the streams to a memory, such as data store 420 for archiving or temporary storage. In a configuration, the proxy server 410 and data store 420 reside in the same hardware. In a configuration, the proxy server 410 can convert each video or audio stream to one or more common formats, sampling or compression rates, and frame sizes. For example, the proxy server 410 can receive a video stream and convert it to a standard H.264 or MPEG video stream prior to storing in data store 420. In a configuration, the proxy server 410 can store two or more different video streams from the same received video stream. For example, the proxy server 410 can convert a received video stream into a small thumbnail-sized video stream and a full size video stream.

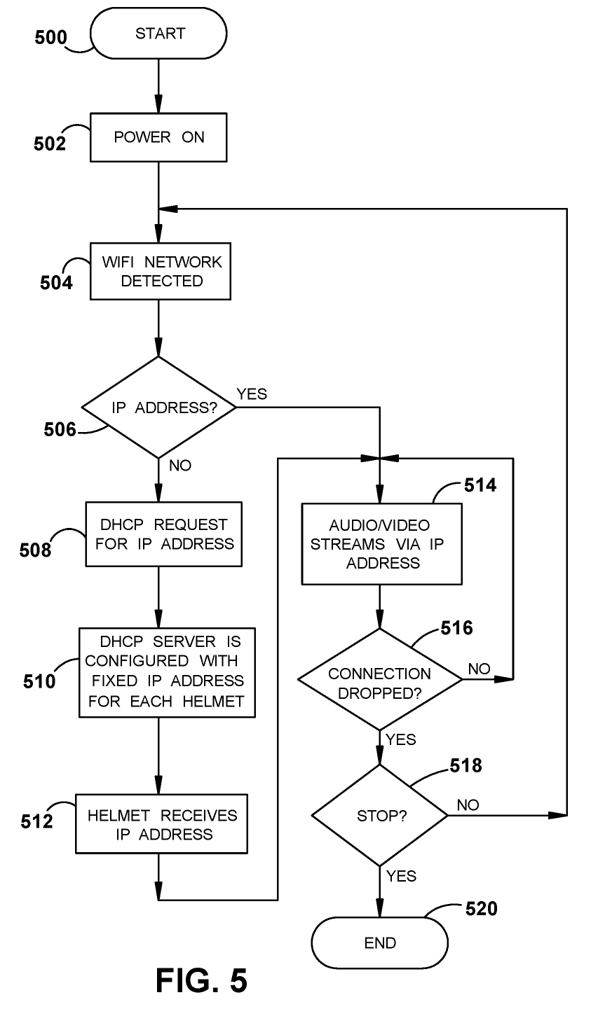

Referring now to FIG. 5, example operations for networking wireless audio and video devices are presented. Operation commences at start block 500 labeled “START” and proceeds to process block 502.

In process block 502, the wireless device is powered on. Processing continues to process block 504.

In process block 504, the wireless device detects a Wi-Fi network. The wireless device can be preconfigured to connect to a specific Wi-Fi network by name, or service set identifier (SSID). The Wi-Fi network may be configured not to broadcast the SSID, for example to prevent the wireless network from being visible on spectators' mobile devices in the arena. In this configuration, the wireless device may detect the Wi-Fi network by querying for the Wi-Fi network using the preconfigured SSID. Processing continues to decision block 506.

In decision block 506, if the wireless device has previously received an IP address, then processing continues to process block 514, otherwise processing continues to process block 508.

In process block 508, the wireless device requests an IP address using the dynamic host control protocol or DHCP. Processing continues to process block 510.

In process block 510, a DHCP server receives the DHCP request from the wireless device and provides an IP address to the wireless device. The DHCP server reserves a fixed IP address for each wireless device. Advantageously, reserving a fixed IP address for each wireless device facilitates determining which video or audio feed belongs to each wireless device. A fixed or reserved IP address simplifies the process of allowing multiple users to receive video feeds from specific wireless devices, as players have helmet cams that may disconnect and reconnect to the Wi-Fi network as they move about the arena during game play. Without fixed or reserved IP addresses, the IP addresses of helmet cams could change during game play and make live streams have to disconnect and reconnect. Processing continues to process block 512.

In process block 512, the wireless device receives the IP address from the DHCP server. Processing continues to process block 514.

In process block 514, the wireless device streams audio and/or video to the proxy server using the configured IP address. Processing continues to decision block 516.

In decision block 516, if the connection to the wireless device drops, then processing continues to decision block 518, otherwise processing continues back to process block 514 to continue streaming the audio and/or video.

In decision block 518, if the connection has dropped due to a power off event or a signal to end streaming, then processing terminates at end block 520, otherwise processing continues back to process block 504 to attempt to reconnect to the Wi-Fi network.

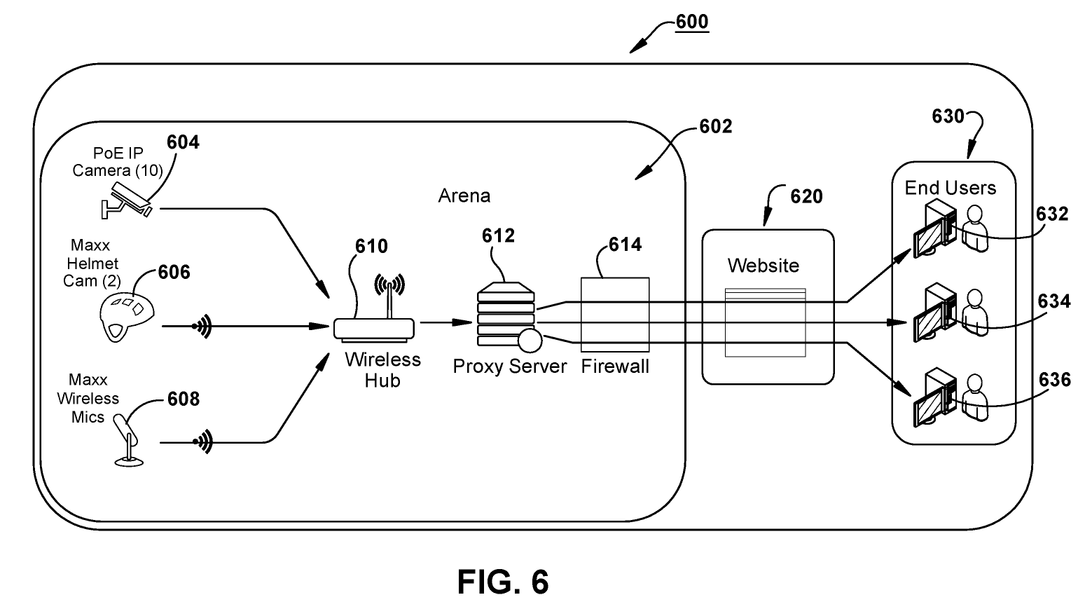

Referring now to FIG. 6, example data connections are illustrated for an embodiment of the audio/video system 600. In an arena 602, such as a hockey arena, a sporting venue, or an entertainment venue in general, one or more fixed or moveable cameras 604, helmet cams 606, and microphones 608 are in data communication with a proxy server 612 through data communications equipment represented by wireless hub 610. The proxy server 612 provides one or more ports through which video and audio data streams can be accessed by users 630, either in real-time or through viewing stored data streams. A firewall 614, such as a specially configured router or dedicated piece of data communications equipment, prevents unauthorized users 630 from accessing data streams from the proxy server 612.

In an embodiment, users 630 first access a website system 620 which provides authentication information for accessing the data streams through the firewall. Authenticated users 630 connect through the firewall to the proxy server 612 and selected data streams are obtained from the proxy server 612 and presented on the users 630 screens. In another embodiment, the website system 620 is able to connect through the firewall 614 and connect to the proxy server 612 that streams to the website system 620. Users 630 that are authenticated on the website system 620 receive data streams that pass through the website system 620 from the proxy server 612.

Multiple end users 630 can simultaneously use the audio/video system 600. The audio/video system 600 can simultaneously support multiple events occurring in different venues. The audio/video system 600 can allow users 630 to create their own customize streams. For example, a first end user 632 can view different live streams from the audio/video system 600 during a particular sporting event. A second end user 634 can generate a customized stream based on a current live stream, or stored data streams of a previous sporting event. A third end user 636 can stream the customized stream of the second end user 634. Each end user 630 can use a different kind of computing devices, for example a mobile device such as a smartphone or tablet, a laptop, a desktop, and so forth. For example, the first end user 632 can be streaming to a mobile computing device that is using a dedicated application or app that has been downloaded to a mobile computing device. The second end user 634 can be using a high end workstation with a fast Internet connection for editing and generating their customized stream. The third end user 636 can be using an Internet browser and clicking a link to access the customized stream of the second end user 636. In a configuration, the bit rate, frame rate, and frame size of the video and audio streams can be optimized for the type of end user computing device and connection speed. In a configuration, an end user can forward a customized stream to a set top box, for example a user of an APPLE mobile device can use APPLE AIRPLAY to stream video to an APPLE TV device in order to play the customized stream on a high definition television. In other configurations, a user can similarly use a suitable streaming media device, set top box, or gaming system such as a FIRETV, ROKU, or XBOX device.

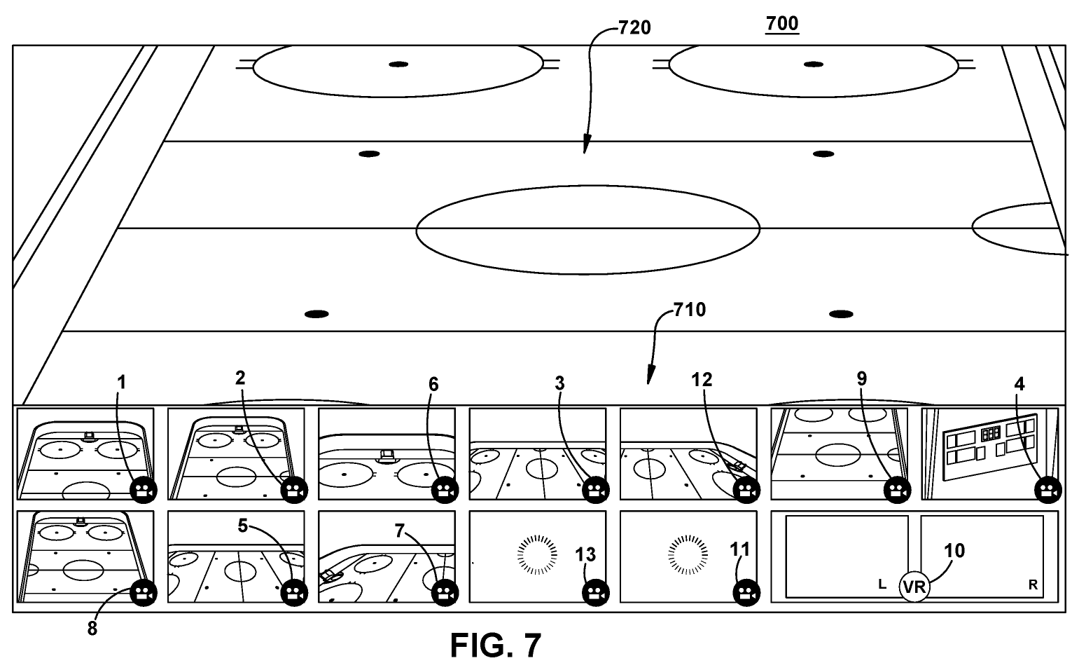

Referring also to FIG. 7, an example screen 700 for selecting from multiple audio and video feeds is presented. The screen 700 includes thumbnail views 710 from each of the cameras and microphones. Some thumbnail views 710 may not include audio or video, either because the feed does not include audio or video, or due to a lost connection. Some thumbnail views, such as thumbnail view 10 may include a left and right view, allowing a user with a 3D viewing device connected to their video device to view a sporting event as a virtual reality experience from one or more of the players' perspectives.

The user can select from one or more of the thumbnail views 710, for example by clicking on a particular thumbnail view 710 or dragging a thumbnail view to a focus window 720. The currently selected video is presented in a focus window 720 that typically is larger than the thumbnail views. Clicking a camera icon associated with each thumbnail view 710 allows a user to select whether video, audio, or both are to be presented to the user, for example via the focus window 720. A user can select video from one device and audio from another device. In an embodiment, the user can customize the screen 700, for example to reorganize the order or size of the thumbnail views 710, to have two or more focus windows. Different user controls and window arrangements can be presented to the user as would be understood in the art. For example, in one configuration the focus window 720 can be selected by the user and clicked to toggle between full screen and the illustrated split screen that includes both the focus window 720 and the thumbnail view 710. In another configuration, clicking on the focus window 720 will cycle between a group of selected thumbnail views 710. This can be particularly useful to a user viewing the event using VR or 3D viewing devices.

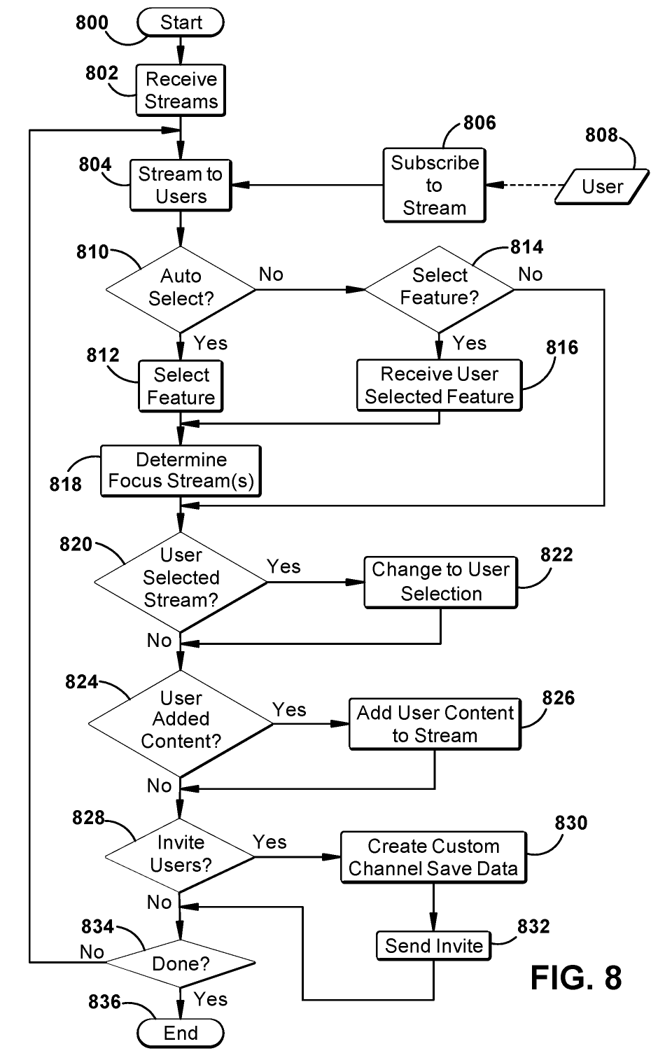

Referring now to FIG. 8, example operations of a system for creating custom content are presented. Users and/or the streaming system itself can choose which devices to display in the focus window or focus windows. Other users can be invited to view the custom created content. Operation commences at start block 800 labeled “START” and proceeds to process block 802.

In process block 802, the streaming system receives streams from devices such as cameras and microphones. Processing continues to process block 804.

In process block 804, the streaming system streams one or more device streams to users 808, for example through the selection screen 700 of FIG. 7. At any time, users 808 can join a live stream of a sporting event or view a saved stream in process block 806. Processing continues to decision block 810.

In decision block 810, if the streaming system is configured to auto-select the focus window, then processing continues to process block 812, otherwise processing continues to process block 814.

In process block 812, the streaming system selects a feature that is used to determine the focus window. For example, the streaming system can select the feature to be the camera where the puck is located, or the microphone that is loudest. The selected feature can change dynamically during the game or practice. For example, the selected feature can be the penalty box subsequent to determining that an official has blown a whistle and the clock has been stopped, or the scoreboard after a change to a score on the scoreboard, or a particular player when that player enters the ice in the arena. In this mode, the streaming system attempts to select devices to present the best user experience of the sporting event. Processing continues to process block 818 where the streaming system determines the focus window based on the selected feature.

In decision block 814, if a user manually selects a feature to use as the selected feature, then processing continues to process block 816 to receive the user selection, otherwise processing continue to decision block 820.

In process block 816, the streaming system receives a selection of a feature to use for selecting the focus window from the available devices. For example, a user who is a scout may desire to follow one particular athlete, and thus use the streaming system in a scouting mode. The scout may select as the feature a jersey number of the particular athlete, in which case the streaming system in process block 818 will determine which camera shows the athlete's jersey number best. In another example, an avid fan of a particular player may desire to have that player as the focus of attention while still watching the game in progress, in which case the camera could be selected that displays both the player and the puck the majority of the time while the selected audio device could be from the helmet of the player or the audio device closest to the player. Processing continues to process block 818.

In process block 818, the streaming system determines the focus window from the available cameras and microphones. The steaming system can track players on the ice, or other playing surface for other sports, and use position and motion data to determine the best camera and microphone to use in the focus window. The streaming system can use the selected feature from process block 812 and/or process block 816 in determining the best device to display in the focus window. The streaming system can determine when a particular device is not streaming, or has a connection issue, and switch to the next best device. Processing continues to decision block 820.

In decision block 820, if a user selects a particular device to use in the focus window, for example to override an selected device by the streaming system from process block 818, the processing continues to process block 822, otherwise processing continues to decision block 824.

In process block 822, the streaming system changes the focus window to the user selected device or devices. Processing continues to decision block 824.

In decision block 824, if the user adds user-content to the content stream, then processing continues to process block 826, otherwise processing continue to decision block 828.

In process block 826, a user adds user-created content to the content stream. For example, the user may have a microphone connected to their computing device and can add live commentary, such as player analysis or real-time play-by-play announcing such as is performed by professional announcers and commentators. In another example, sophisticated users can include user-created video such as replay clips or on-screen annotation. Processing continues to decision block 828.

In decision block 828, if the stream is offered to users, then processing continues to process block 830, otherwise processing continues to decision block 834.

In process block 830, a custom stream can be saved. In one configuration, metadata is saved that includes time-stamped tracking of which device(s) were selected for the focus window(s). In this way, the custom stream can be recreated as needed from saved video streams. In another configuration, a new stream can be saved separately for each custom created stream. In another configuration, the original sources or streams can be saved for a configurable period of time, and then purged at a particular expiration date to recover storage space. Similarly, custom streams can be saved and stored for a period of time before being purged. For example, a single custom stream created by the streaming system might be stored indefinitely, while the remaining streams are purged. Processing continues to process block 832.

In process block 832, users can be invited to view a custom stream. For example, a stream automatically generated by the streaming system can be shown on a schedule of available live or saved games for viewing by users. The streaming system can also include user-create custom streams in the schedule, and allow other users to rate user-created streams. In another example, a user that creates custom content can generate a link to their custom stream that can be forwarded to other users, for example through social media. For example, a link can be placed on a FACEBOOK page, a clip and link uploaded to the user's INSTAGRAM account, or a link can be emailed to potentially interested parties, for example using an email list and advertisement. Other uses of social media, either currently extant or yet to be developed, can be utilized as would be understood by one of skill in the art. Processing continues to decision block 834.

In decision block 834, if the sports event is determined to be over or if the saved stream has concluded, then processing terminates at end block 836, otherwise processing continues back to process block 804 to continue streaming content to users.

The costs of creating audio-video content are substantially reduced by allowing users, or the streaming system itself, to determine which video and audio stream to use as the focus window(s), especially when compared to the costs incurred by professional broadcast services such as the major television networks. Further, the use of relatively inexpensive cameras, microphones, and networking equipment allows that equipment to be more or less permanently placed in a sporting venue and used for whatever events occur in the venue, when they are sporting events, entertainment events, or other events. This opens the opportunity to allow streaming of practices, pre-season games, minor-league games, club-level events, and even high-school events to interested parties. In effect, the present system democratizes the capture, production, and distribution of content from all levels of sporting venues.

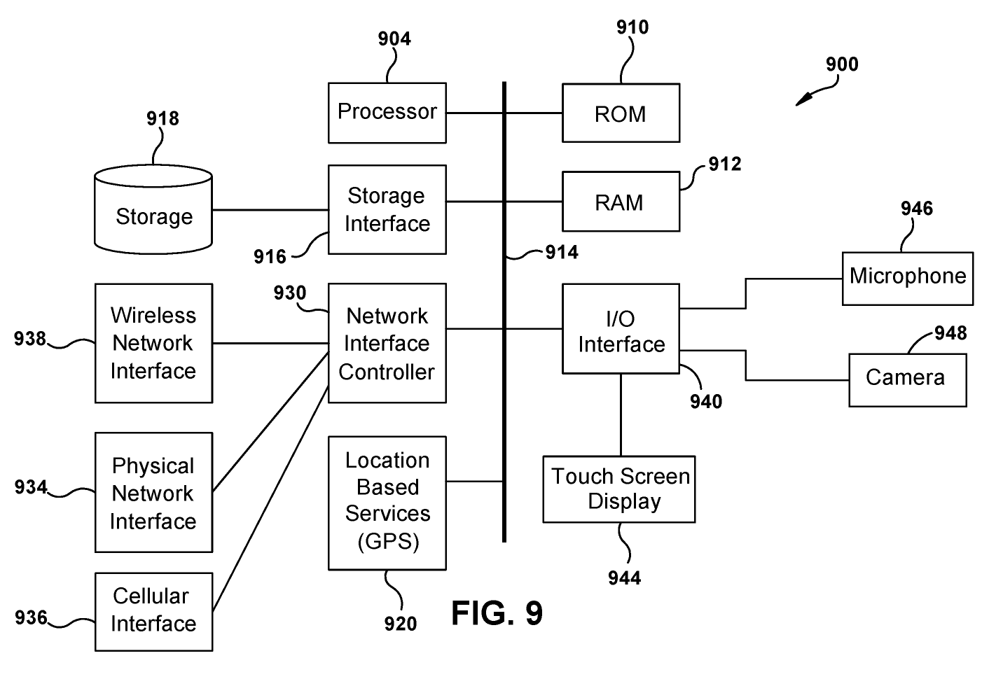

Referring now to FIG. 9, an example computing device 900 is presented. Example computing devices 900 can be servers, desktop systems, mobile computing devices, embedded controllers, wireless cams and microphones, and so forth. Included are one or more processors, such as that illustrated by processor 904. Each processor is suitably associated with non-volatile memory, such as read only memory (ROM) 910 and random access memory (RAM) 912, via a data bus 914.

Processor 904 is also in data communication with a storage interface 916 for reading or writing to a data storage system 918, suitably comprised of a hard disk, memory or solid-state disk, or any other suitable data storage as will be appreciated by one of ordinary skill in the art.

Processor 904 is also in data communication with a network interface controller (NIC) 930, which provides a data path to any suitable wired or physical network connection via physical network interface 934, or to any suitable wireless data connection via wireless network interface 938 or cellular interface 936, such as one or more of the networks detailed above.

Processor 904 is also in data communication with an input/output (I/O) interface 940 which provides data communication with devices such as a microphone 946 or camera 948 or user peripherals, such as a touchscreen display 944, keyboard, or mouse or any other suitable user interface. It will be understood that functional units are suitably comprised of intelligent units, including any suitable hardware or software platform.

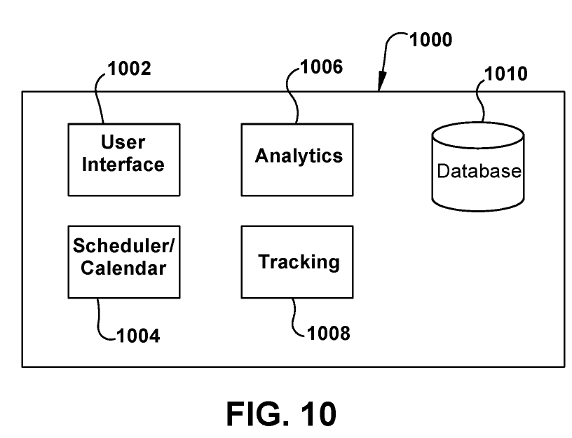

Referring now to FIG. 10, presented are example software modules of an embodiment of the website system of FIG. 6. A user interface module 1002 serves web pages to users and administrators that provides a graphical user interface for logging into the system, viewing calendars of upcoming sporting events and archived streams, selecting sporting events or recorded steams to view, receiving video and audio streams from the proxy server through the firewall, customizing the user's thumbnail and focus window views, and interacting with the system in general. User accounts, configuration data, calendar information, stream information, and other data can be stored in a database 1010 or other suitable memory. A scheduler engine 1004 can schedule recordings of sporting events by the proxy server.

An analytics engine 1006 can analyze video and audio streams. For example, the analytics engine 1006 can determine when a video or audio feed has disconnected, and switch a user's focus window to another available stream and switch back once the video or audio feed reconnects. Similarly, the analytics engine 1006 can monitor video or audio streams and either blackout some or all of a stream in real-time, or switch the focus window to a different stream. The analytics engine 1006 can be used to detect objectionable language in audio, or objectionable images in a video feed, for example nudity, political messages, unauthorized advertising, excessive violence, and so forth. In a configuration, the analytics engine 1006 can be rules-based or use heuristics or other suitable analytics to perform an analysis of one or more streams.

The analytics engine 1006 can also track selected features for determining which stream to use in a focus window. For example, when the website system in being used by a user that is a scout, or if the system is set to use a scout mode, an individual player can be tracked in multiple video streams, for example by jersey number. The analytics engine 1006 can determine the optimal video and audio streams to use to track the selected player or feature being tracked.

The analytics engine 1006 can also perform analysis of helmet cam video and/or audio, for example to track where a player is looking or to determine how the player is moving the helmet. The analytics engine 1006 can determine if rapid helmet movements are suggestive of violent impacts which could cause concussions. The analytics engine 1006 can monitor a helmet cam for video and/or audio that might indicate a concussion, injury, or exhaustion of the player. For example, movements of the helmet that are atypical for the player, such as looking down more often, looking up, not turning the head in one particular direction, not following the puck or a delay in following the puck or action of the game, not looking where other players are looking, and so forth. In a configuration, a player's typical pattern of helmet movements can be analyzed and saved for reference and comparison. In a configuration, a player's vital signs can be sensed and streamed in real-time in addition to the audio/video stream, including but not limited to brain waves, heart rate, temperature, respiration, and blood pressure. In a configuration, the analytics engine 1006 can send an alert to a coach or medical professional via a text message, email, or other suitable alert, for example using the user interface 1002. In a configuration, the players vitals can be superimposed on a video stream, for example to provide an augmented reality experience to the user.

A tracking engine 1008 can track one or more players' movements in the arena. The tracking engine 1008 can turn a player's movements into vector data, or any other suitable position data. The tracking engine 1008 can work in conjunction with the analytics engine 1006. For example, the tracking engine 1008 can provide player position or vector data to the analytics engine 1006 that is used to determine which camera and audio feed to use in the focus window(s). In a configuration, each player can be analyzed to create a digital representation of the players. Example data that can be determined can include position, speed, direction, acceleration, deceleration, linearity, non-linearity, circularity, time, and other measurements as would be understood in the art. In a configuration, the tracking engine 1008 and analytics engine 1006 can determine the correct camera frame to provide to a user based on the player data. For example, the system can sum all of the vectors or kinetic energy for each frame and/or camera stream and switch the focus window to a particular camera stream based on that calculation.

In a configuration, tracking data can be combined with video data to provide a visual representation of players' movements during practice or a game. Similarly, tracking data and/or analytics data can be combined with video and/or audio data to provide player performance information to couches, scouts, and interested viewers and fans.

In a configuration, the tracking engine 1008 can receive position data from helmet cams, for example position data derived from GPS or radio signal triangulation. Tracking and analytics data can be stored in the database 1010 or any other suitable memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A method of generating a user customized video stream, comprising:
capturing a plurality of video streams of an event, each video stream comprising a capture of video from one of a plurality of image capturing devices;
receiving a user selection;
determining a focus video stream based at least in part on the user selection, the focus stream comprising a first video stream of the plurality of video streams;
changing the focus video stream from the first video stream to a second video stream of the plurality of video streams; and
generating a user customized video stream from the focus video stream.

2. The method of claim 1, wherein the user selection is a selection of a feature, and
wherein the focus video stream is changed from the first video stream to the second video stream based at least in part on the selected feature.

3. The method of claim 2, wherein the event is a sporting event, and wherein the feature is a selected player associated with the sporting event.

4. The method of claim 3, wherein determining the focus video stream further comprises:
analyzing at least a subset of the plurality of video streams to determine if the selected player is visually present in a video stream;
identifying at least one video stream where the selected player is visually present; and
selecting the first video stream from one of the identified video streams where the selected player is visually present.

5. The method of claim 4, wherein the operation of analyzing further comprises:
identifying, using an image processing algorithm, the selected player by a number on a uniform of the selected player.

6. The method of claim 1, wherein the user selection is a selection of one of the plurality of video streams, and further comprising:
receiving a second user selection,
wherein the focus video stream is changed from the first video stream to the second video stream in accordance with the second user selection.

7. The method of claim 1, further comprising:
receiving user created content; and
incorporating the received user created content with the focus video stream to generate the user customized video stream.

8. The method of claim 1, further comprising:
storing the user customized video stream;
associating the user customized video stream with a user created channel; and
inviting other users to stream a user customized video stream associated with the user created channel.

9. The method of claim 1, wherein each image capturing device is selected from the group consisting of a video camera disposed in a public venue associated with the event, and a wireless video camera disposed on a person associated with the event.

10. A system for generating a user customized video stream, comprising:
a video server configured to store a plurality of captured video streams of an event;
an input configured to receive a user selection; and
a processor configured to
determine a focus video stream based at least in part on the user selection, the focus stream comprising a first video stream selected from the plurality of video streams stored on the video server,
change the focus video stream from the first video stream to a second video stream of the plurality of video streams, and
generate a user customized video stream from the focus video stream.

11. The system of claim 10, further comprising:
a plurality of image capturing devices, each disposed at a different vantage point, in a public venue associated with the event,
wherein at least a subset of the video streams stored on the video server are captured from the plurality of image capturing devices.

12. The system of claim 11, further comprising:
a wireless video camera disposed on a person associated with the event,
wherein at least one video stream stored on the video server is captured from the wireless video camera.

13. The system of claim 12, wherein the user selection is a selection of a feature, and
wherein the processor is further configure to change the focus video stream from the first video stream to the second video stream based at least in part on the selected feature.

14. The system of claim 13, wherein the event is a sporting event, and wherein the feature is a selected player associated with the sporting event.

15. The system of claim 14, wherein the processor is further configured to analyze at least a subset of the plurality of video streams to determine if the selected player is visually present in one or more of the video streams,
wherein the processor is further configured to identify at least one video stream where the selected player is visually present, and
wherein the processor is further configured to select the first video stream from an identified video stream where the selected player is visually present.

16. The system of claim 15, wherein the processor is further configured to identify the selected player by a number on a uniform of the selected player.

17. The system of claim 10, wherein the user selection is a selection of one of the plurality of video streams,
wherein the input is further configured to receive a second user selection, and
wherein the processor is further configured to change the focus video stream from the first video stream to the second video stream in accordance with the second user selection.

18. The system of claim 10, wherein the input is further configured to receive user created content, and
wherein the processor is further configured to incorporate the user created content with the focus video stream to generate the user customized video stream.

19. The system of claim 10, wherein the video server is further configured to store the user customized video stream and associate the user customized video stream with a user created channel, and
wherein the processor is further configured to invite other users to stream a user customized video stream associated with the user created channel.

20. A system for generating a user created video stream, comprising:
an audio/video server configured to store audio/video streams captured during a sporting event at the sporting venue, each audio/video stream being associated with an audio/video capturing device selected from the group consisting of a wireless helmet camera associated with a player, a microphone positioned to detect sound during the event from one or more players in the sporting venue, and a video camera positioned at a unique vantage point in the sporting venue; and
a processor configured to dynamically determine which audio/video streams to select, in accordance with a user input received on an associated user interface, during playback of the sporting event as a user customized video stream,
wherein the user interface displays at least a subset of audio/video streams to a user,
wherein the processor is further configured to select an audio/video stream based on a user selection of one of the displayed audio/video streams, and
wherein the processor is further configured to perform image processing on one or more audio/video streams to determine if a user selected player is visually present in the one or more audio/video streams, and dynamically select an audio/video stream in accordance with the visual presence of the user selected player in the audio/video stream.
